(19) United States
(12) Patent Application Publication
(10) Pub. No.: US 2008/0301880 A1
(43) Pub. Date: Dec. 11, 2008

(54) POWER SCREW GUN WITH HAMMER HEAD

(76) Inventor: Norman D. Calvert, Marcellus, MI (US)

Correspondence Address: Mathew R. P. Perrone, Jr., 210 South Main Street, Algonguin, IL, 60102, US

(21) Appl. No.: 11/761,022

(22) Filed: Jun. 11, 2007

(51) Int. Cl. B25F 1/00

(52) U.S. Cl. 7/143

(57) ABSTRACT

A pneumatic power screw gun with a reinforced hammer head, has a reinforced base end above the handle with a cradle mounted thereon, the cradle being adapted to receive and secure a hammer head in place as desired.

This invention relates to a power screw gun with a hammer head and more particularly to a pneumatic power screw gun with a reinforced hammer head.

### BACKGROUND OF THE INVENTION

In a process of using a powered screw gun, it becomes necessary to strike the screw at times and finish a setting of for the screw in the desired surface. To that end, a worker will commonly use the butt end of the powered screw gun to set a screw. A powered screw gun is not designed for such use as a hammer.

When a powered screw gun is used as a hammer, the screw gun must suffer some damage. The damage may cause either damage on the external casing or internal powered source of the screw gun. Thus, there is an advantage in minimizing damage to the powered screw gun.

### SUMMARY OF THE INVENTION

Among the many objectives of the present invention is the provision of a pneumatic power screw gun with a reinforced hammer head.

Another objective of the present invention is the provision of a pneumatic power screw gun with a replaceable hammer head.

Yet another objective of the present invention is the provision of a pneumatic power screw gun with a reinforced mounting for a hammer head.

These and other objectives of the invention (which other objectives become clear by consideration of the specification, claims and drawings as a whole) are met by providing a pneumatic power screw gun with a reinforced hammer head, having a reinforced butt end with a stamped cradle mounted thereon, the stamped cradle being adapted to receive a hammer head.

### BRIEF DESCRIPTION OF DRAWINGS

FIG. 1 depicts a block diagram of the reinforced hammer head 100 of this invention mounted on a screw gun 110.

FIG. 2 depicts a side view of the reinforced hammer head 100 of this invention mounted on a screw gun 110.

FIG. 3 depicts a rear plan view of the other hammer cradle 120 for hammer head 100 of this invention.

FIG. 4 depicts a side view of the hammer head 100 of this invention.

FIG. 5 depicts a perspective view of the hammer head 100 of this invention.

Throughout the figures of the drawings, where the same part appears in more than one figure of the drawings, the same number is applied thereto.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, may be used with respect to the drawings. These and similar to directional term are not to be construed to limit the scope of the invention in any manner. The words attach, connect, couple, and similar terms with their inflectional morphemes do not necessarily denote direct or intermediate connections, but may also include connections through mediate elements or devices.

The hammerhead of this invention is mounted on a rear portion of the power screw gun. The screw gun has a barrel with a screw ejecting end and operably disposed base end. Adjacent the base end a handle extends there below. At the juncture of the handle and the barrel is the trigger for the screw gun.

To the base end of the screw gun is secured a hammerhead cradle. Into the cradle is fitted a hammerhead. The hammerhead has a locking base which fits into the cradle in a slidable fashion. The locking base is in a male to female relationship with the cradle. A slide lock releasably secures the hammerhead in the cradle. Oppositely disposed from the locking base of the hammerhead is the striking head.

Because the cradle reinforces the base end of the screw gun, the striking head may be used with little or no damage to the screw gun. With the locking base securing the hammerhead in place, great efficiency is achieved by having a hammer ready for use.

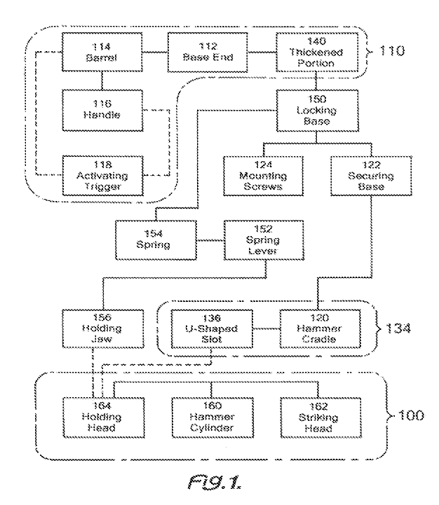

Referring now to FIG. 1, hammer head 100 is secured on screw gun 110 at the butt end or the base end 112. Base end 112 extends into barrel 114 of screw gun 110. Below barrel 114 and extending from the base end 112 is handle 116 of the 110. The actuating trigger 118 of screw gun 110 is positioned between handle 116 and barrel 114. To base end 112 is secured hammer cradle 120, by welding, bolting, gluing or other appropriate means. Hammer head 100 fits into hammer cradle 120. Base end 112 can be made with a thickened portion 140, can rely on the hammer cradle 120 or can have combinations thereof in order to provide the desired strength for mounting the hammerhead on the screw gun.

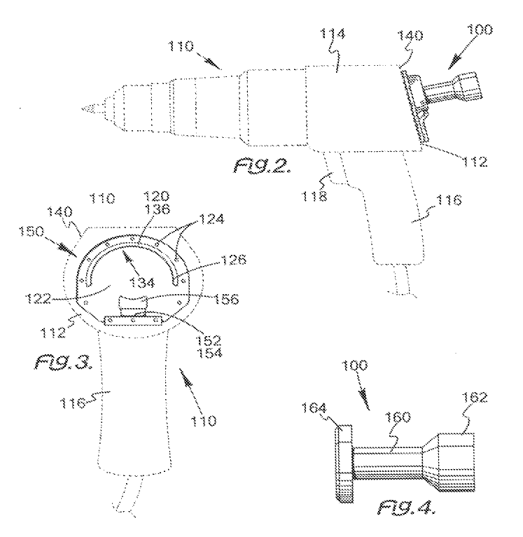

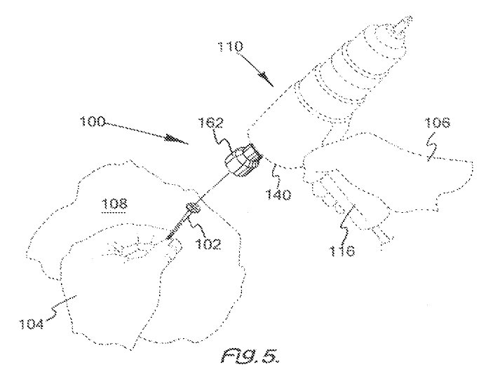

Adding FIG. 2, FIG. 3, FIG. 4 and FIG. 5 to the consideration, the structure of hammerhead 100 becomes more clear. Screw gun 110 has base end 112 with a thickened portion 140, onto which, the hammer cradle 120 may be mounted. Locking base 150 includes a securing base 122 of hammer cradle 120, which is directly secured to base end 112. More particularly, mounting screws 124 secure mounting rim 126 of locking base 150 to base end 112.

Extending upwardly from mounting rim 126 is hammer receiver 134. Hammer receiver 134 has a U-shaped slot 136 adapted to receive hammer head 100. At least partially closing the U-shaped slot 136 is a spring lever 152 with spring 154 supporting the spring lever 152. Spring lever 152 extends into holding jaw 156 to contact hammer head 100

Hammer head 100 has a holding head 164 adapted to slide into U-shaped slot 136. As holding head 164 (FIG. 4) slides into U-shaped slot 136, spring lever 152 is depressed. As holding head 164 exposes spring lever 152, it rises from its depression due to spring 154 secured thereunder and engages holding head 164 with holding jaw 156. In this manner, spring lever 152 and U-shaped slot 136 cooperate to hold hammer head 100 in place.

To remove or replace hammer head 100, spring lever 152 is depressed, and hammer head 100 is removed from hammer receiver 134. Mounting of the hammerhead 100 on the hammer receiver 134 requires a reverse procedure. The holding head 164 of hammerhead 120 extends along to hammer cylinder 160 and then into striking head 162 of hammerhead 100. With the support of locking base 150, striking head 162 of hammerhead 100 may be effectively used, with greatly reduced or eliminated damage to screw gun 110.

Adding more consideration from FIG. 5, screw 102 is held by steadying hand 104 adjacent to a screw receiving surface 108. Screw gun hand 106 adjusts screw gun 110 so that striking head 162 of hammer head 100 can contact screw 102, either before or after using the screw gun 110 to drive screw 102. Thus, setting of screw 102 becomes much more efficient.

This application—taken as a whole with the abstract, specification, claims, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this tool can become clear to a person having ordinary skill in this particular art. Such modifications are clearly covered by this disclosure.

What is claimed and sought to be protected by Letters Patent is:

1. A reinforced hammer head support for a portable power screw driver comprising:
a) the portable power screw driver having a reinforced base end, a handle and a barrel;
b) the reinforced base end being situated above the handle;
c) the reinforced base end extending into the barrel;
d) the reinforced base end having a cradle mounted thereon; and
e) the cradle being adapted to receive and secure the hammer head in place.

2. The reinforced hammer head support of claim 1 further comprising:
a) a hammer head fitting securely into the cradle;
b) the hammerhead having a locking base to mount into the cradle in a slidable fashion;
c) a slide lock releasably securing the hammerhead in the cradle; and
d) a striking head for the hammerhead being oppositely disposed from the locking base.

3. The reinforced hammer head support of claim 2 further comprising:
a) the cradle reinforcing the base end of the screw gun with the striking head used with little or no damage to the screw gun;
b) the cradle being secured to the base end of the power screw gun;
c) the cradle having a mounting rim for a hammer receiver;
d) the hammer receiver having a U-shaped slot adapted to receive hammer head; and
e) a spring lever at least partially closing the U-shaped slot in order to releasably hold the hammer head therein.

4. The reinforced hammer head support of claim 3 further comprising:
a) the base end having a thickened portion to receive the cradle;
b) the hammerhead having a holding head, a hammer cylinder and a striking head;
c) the holding head extending into the hammer cylinder; and
d) the hammer cylinder extending into the striking head.

5. The reinforced hammer head support of claim 4 further comprising:
a) the cradle providing a locking base to receive the hammer head;
b) the cradle including a securing base for mounting on the base end; and
c) a mounting means securing the cradle on the base end.

6. The reinforced hammer head support of claim 5 further comprising:
a) the mounting rim being secured to the base end with glue, welding, or screws;
b) a hammer receiver extending upwardly from the mounting rim;
c) the hammer receiver having a U-shaped slot to receive the hammer head; and
d) a flexible securing means at least partially closing the U-shaped slot in order to releasably secure the hammer head therein.

7. The reinforced hammer head support of claim 6 further comprising:
a) the securing means being a spring lever movably supported by a spring;
b) the holding head being adapted to depress the spring lever in order to mount the hammer head into the U-shaped slot; and
c) the spring lever being depressable in order to mount the hammer head into the U-shaped slot.

8. In a portable power screw driver comprising a base end, a barrel and a handle wherein the base end extends into the barrel and the handle extends from the base end below the barrel, the improvement including a reinforced hammer head support on the base end and further comprising:
a) the portable power screw driver having a reinforced base end;
b) the reinforced base end being situated above the handle;
c) the reinforced base end extending into the barrel;
d) the reinforced base end having a cradle mounted thereon; and
e) the cradle being adapted to receive and secure the hammer head in place.

9. The portable power screw driver of claim 8 further comprising:
a) a hammer head fitting securely into the cradle;
b) the hammerhead having a locking base to mount into the cradle in a slidable fashion;
c) a slide lock releasably securing the hammerhead in the cradle; and
d) a striking head for the hammerhead being oppositely disposed from the locking base.

10. The portable power screw driver of claim 9 further comprising:
a) the cradle reinforcing the base end of the screw gun with the striking head used with little or no damage to the screw gun;
b) the cradle being secured to the base end of the power screw gun;
c) the cradle having a mounting rim for a hammer receiver;
d) the hammer receiver having a U-shaped slot adapted to receive hammer head; and
e) a spring lever at least partially closing the U-shaped slot in order to releasably hold the hammer head therein.

11. The portable power screw driver of claim 10 further comprising:
a) the base end having a thickened portion to receive the cradle;
b) the hammerhead having a holding head, a hammer cylinder and a striking head;
c) the holding head extending into the hammer cylinder; and
d) the hammer cylinder extending into the striking head.

12. The portable power screw driver of claim 10 further comprising:
a) the cradle providing a locking base to receive the hammer head;
b) the cradle including a securing base for mounting on the base end; and
c) a mounting means securing the cradle on the base end.

13. The portable power screw driver of claim 12 further comprising:
a) the mounting rim being secured to the base end with glue, welding, or screws;
b) a hammer receiver extending upwardly from the mounting rim;
c) the hammer receiver having a U-shaped slot to receive the hammer head; and
d) a flexible securing means at least partially closing the U-shaped slot in order to releasably secure the hammer head therein.

14. The reinforced hammer head support of claim 13 further comprising:
a) the securing means being a spring lever movably supported by a spring;
b) the holding head being adapted to depress the spring lever in order to mount the hammer head into the U-shaped slot; and
c) the spring lever being depressable in order to mount the hammer head into the U-shaped slot.

15. A method of using a power screw with a hammer head mounted thereon comprising:
a) providing a portable power screw driver comprising a base end, a barrel and a handle wherein the base end extends into the barrel and the handle extends from the base end below the barrel;
b) adding a reinforced hammer head support on the base end;
c) providing the portable power screw driver with a reinforced base end;
d) situating the reinforced base end above the handle;
e) extending the reinforced base end into the barrel;
f) mounting a cradle on the reinforced base end; and
g) releasably securing a hammerhead in the cradle.

16. The method of claim 15 further comprising:
a) securing the head into the cradle with a slide lockpring lever;
b) providing a locking base on the hammerhead to mount into the cradle in a slidable fashion; and
c) providing a striking head for the hammerhead oppositely disposed from the locking base and connected by a hammer cylinder.

17. The method of claim 16 further comprising:
a) causing little or no damage to the screw gun as the hammer head is used due the cradle reinforcing the base end of the screw gun;
b) securing the cradle to the base end of the power screw gun;
c) providing a mounting rim for the cradle having as a hammer receiver;
d) providing a U-shaped slot adapted to receive the hammer head on the hammer receiver; and
e) providing a spring lever to at least partially close the U-shaped slot in order to releasably hold the hammer head therein.

18. The method of claim 17 further comprising:
a) providing a thickened portion on the base end to receive the cradle; and
b) providing the hammerhead with a holding head, a hammer cylinder and a striking head so that the holding head extends into the hammer cylinder and the hammer cylinder extends into the striking head.

19. The method of claim 18 further comprising:
a) the cradle providing a locking base to receive the hammer head;
b) the cradle including a securing base for mounting on the base end; and
c) a mounting means securing the cradle on the base end.

20. The method of claim 19 further comprising:
a) the mounting rim being secured to the base end with glue, welding, or screws;
b) a hammer receiver extending upwardly from the mounting rim;
c) the hammer receiver having a U-shaped slot to receive the hammer head;
d) a flexible securing means at least partially closing the U-shaped slot in order to releasably secure the hammer head therein;
e) the securing means being a spring lever movably supported by a spring;
f) the holding head being adapted to depress the spring lever in order to mount the hammer head into the U-shaped slot;
g) the spring lever being depressable in order to mount the hammer head into the U-shaped slot;
h) a screw being held by a steadying hand adjacent to a screw receiving surface; and
i) a screw gun hand adjusting the screw gun so that the striking head of hammer head can contact screw, either before or after using the screw gun to drive the screw.
